(19) United States
(12) Patent Application Publication
(10) Pub. No.: US 2015/0063555 A1
(43) Pub. Date: Mar. 5, 2015

(54) APPARATUS, METHODS, COMPUTER SOFTWARE AND COMPUTER PROGRAM PRODUCTS FOR TELECOMMUNICATIONS SERVICE MIGRATION

(71) Applicant: Metaswitch Networks Ltd, Enfield (GB)

(72) Inventor: Alan Scott THOMAS, Carmel, IN (US)

(21) Appl. No.: 14/472,014

(22) Filed: Aug. 28, 2014

Related U.S. Application Data
(60) Provisional application No. 61/872,058, filed on Aug. 30, 2013.

(51) Int. Cl. H04Q 3/00

(52) U.S. Cl. CPC H04Q 3/0083; H04Q 2213/13196
USPC 379/221.01

(57) ABSTRACT

Apparatus, methods, computer software and computer program products for telecommunications service migration. The telecommunications service is being migrated from legacy telecommunications equipment to replacement telecommunications equipment. A first set of cables is communicatively coupled to the legacy telecommunications equipment. The legacy telecommunications equipment is communicatively coupled to a first gateway unit. The first gateway unit is communicatively coupled to a second gateway unit. A second set of cables is communicatively coupled to the second gateway unit. The second gateway unit is communicatively couplable to the replacement telecommunications equipment. This enables data associated with the telecommunications service to be communicated between the second gateway unit and the legacy telecommunications equipment via the first gateway unit prior to the telecommunications service being migrated to the replacement telecommunications equipment. The second gateway unit may communicate such data with the replacement telecommunications equipment after the telecommunications service is migrated to the replacement telecommunications equipment.

### CROSS-REFERENCE TO RELATED APPLICATIONS

This application claims priority under 35 U.S.C. §120 to U.S. Application No. 61/872,058, filed Aug. 30, 2013, the content of which is hereby incorporated herein by reference in its entirety.

### BACKGROUND OF THE INVENTION

1. Field of the Invention

The present disclosure relates to telecommunications service migration.

2. Description of the Related Technology

There are various reasons for migrating telephony traffic from a legacy telephony switch to a replacement telephony switch. For example, the replacement telephony switch might provide more modern switching services and functionality.

In one known technique for migrating traffic, traffic is moved from the old switch to the new switch in the same way as new traffic would be added to the new switch. In this technique, a new set of cables is run to the new switch and traffic on the old switch is simply deleted from the old switch and added to the new switch. This delete-and-add procedure may be performed, for example, during maintenance windows. Small amounts of traffic may be migrated during each maintenance window.

A relatively small telephony switch might have the capacity for in the region of 10,000 ports (or ‘telephone lines’). Each call handled by the switch typically involves at least two telephone lines, for example one telephone line for the calling party and another telephone line for the called party. A telephone call may involve more than two lines, for example if it is a conference call involving three or more call parties. A relatively small switch might therefore have the capacity to handle in the region of 5,000 simultaneous calls. In reality, the maximum number of simultaneous calls that such a switch can handle may be smaller than this theoretical maximum owing to other factors such as blocking. In practice, it might take several weeks to migrate all of the traffic from a relatively small switch to the new switch.

A relatively large telephony switch might have in the region of 100,000 ports. It might therefore take several months to migrate all of the traffic from a relatively large switch to the new switch.

In some situations, it might be desired to migrate traffic from several or even a large number of relatively large switches. For example, it might be desired to migrate traffic from 100, or maybe even 1,000, relatively large switches. Such migration could take many years to perform, which may be longer than the life expectancy of the replacement switch where the simple delete-and-add process is being used. In some such situations, a service provider might need to start a new round of migration before the initial round of migration is completed.

Furthermore, when migrating a service using the delete-and-add process, all services either need to be duplicated in the old and new switches or need to be moved as a whole at one time. For example, it might be desired to migrate a business service from an old switch to a new switch. An example of such a service includes a Private Branch Exchange (PBX)-like service that allows for four-digit inter-office dialing, intercom, and other features. Some such services may use in the region of 10,000 lines. If only some of the telephone lines for the business group associated with the service are moved to a new switch, it can be difficult to maintain all of the lines as one group. As a result, the service may not function correctly until all of the lines have been moved to the new switch. This creates a degree of service separation. Although there are known ways to maintain the lines as a group in such scenarios, they are generally either expensive and/or complicated.

It would therefore be desirable to provide improved solutions for migrating a telephony service.

### SUMMARY

In accordance with first embodiments, there is apparatus configured to be used in migrating at least one telecommunications service from legacy telecommunications equipment to replacement telecommunications equipment in a telecommunications network, the apparatus may comprise:

the legacy telecommunications equipment from which the at least one telecommunications service is to be migrated, the legacy telecommunications equipment having a first set of cables communicatively coupled thereto to enable data associated with the at least one telecommunications service to be communicated via the telecommunications network;

a first gateway unit communicatively coupled to the legacy telecommunications equipment; and

a second gateway unit having a second set of cables communicatively coupled thereto to enable data associated with the at least one telecommunications service to be communicated via the telecommunications network, wherein:

the second gateway unit is communicatively coupled to the legacy telecommunications equipment via the first gateway unit to enable data associated with the at least one telecommunications service to be communicated between the second gateway unit and the legacy telecommunications equipment via the first gateway unit prior to the at least one telecommunications service may be migrated to the replacement telecommunications equipment; and

the second gateway unit is communicatively couplable to the replacement telecommunications equipment to which the at least one telecommunications service is to be migrated.

In accordance with second embodiments, there is a method of configuring apparatus to be used in migrating at least one telecommunications service from legacy telecommunications equipment to replacement telecommunications equipment in a telecommunications network, the apparatus may comprise:

the legacy telecommunications equipment from which the at least one telecommunications service is to be migrated, the legacy telecommunications equipment having at least a first set of cables communicatively coupled thereto to enable data associated with the at least one telecommunications service to be communicated via the telecommunications network;

a first gateway unit; and

a second gateway unit that is communicatively couplable to the replacement telecommunications equipment to which the at least one telecommunications service is to be migrated, the method may comprise:

communicatively coupling a second set of cables to the second gateway unit to enable data associated with the at least one telecommunications service to be communicated via the telecommunications network;

communicatively coupling the second gateway unit to the first gateway unit; and

communicatively coupling the first gateway unit to the legacy telecommunications equipment.

In accordance with third embodiments, there is a method of configuring a set of gateway units to be used in migrating at least one telecommunications service from legacy telecommunications equipment to replacement telecommunications equipment in a telecommunications network, the set of gateway units may comprise at least a first gateway unit and a second gateway unit, the method may comprise:

communicatively coupling the first gateway unit to legacy telecommunications equipment from which the at least one telecommunications service is to be migrated, the legacy telecommunications equipment having a first set of cables communicatively coupled thereto to enable data associated with the at least one telecommunications service to be communicated via the telecommunications network;

communicatively coupling the second gateway unit to the legacy telecommunications equipment via the first gateway unit, the second gateway unit having a second set of cables communicatively coupled thereto to enable data associated with the at least one telecommunications service to be communicated via the telecommunications network, the second gateway unit may be communicatively couplable to the replacement telecommunications equipment to which the at least one telecommunications service is to be migrated; and

enabling data associated with the at least one telecommunications service to be communicated between the second gateway unit and the legacy telecommunications equipment via the first gateway unit prior to the at least one telecommunications service may be migrated to the replacement telecommunications equipment.

In accordance with fourth embodiments, there is a set of gateway units configured to be used in migrating at least one telecommunications service from legacy telecommunications equipment to replacement telecommunications equipment in a telecommunications network, the set of gateway units may comprise at least a first gateway unit and a second gateway unit, wherein:

the first gateway unit may comprise:

a first communications interface via which the first gateway unit is communicatively couplable to the legacy telecommunications equipment from which the at least one telecommunications service is to be migrated;

a second communications interface via which the first gateway unit is communicatively couplable to the second gateway unit; and

at least one processor operable to enable data associated with the at least one telecommunications service to be communicated between the second gateway unit and the legacy telecommunications equipment via the first communications interface of the first gateway unit and second communications interfaces of the first gateway unit; and

the second gateway unit may comprise:

a first communications interface via which the second gateway unit is communicatively couplable to the first gateway unit;

a second communications interface to which a set of set of cables are connectable to enable data associated with the at least one telecommunications service to be communicated via the telecommunications network;

a third communications interface via which the second gateway unit is communicatively couplable to the replacement telecommunications equipment; and

at least one processor operable to enable data associated with the at least one telecommunications service to be communicated, selectively, with the legacy telecommunications equipment via the first communications interface of the second gateway unit or with the replacement telecommunications equipment via the third communications interface of the second gateway unit.

In accordance with fifth embodiments, there is computer software adapted to perform a method of configuring a set of gateway units to be used in migrating at least one telecommunications service from legacy telecommunications equipment to replacement telecommunications equipment in a telecommunications network, the set of gateway units may comprise at least a first gateway unit and a second gateway unit, the method may comprise:

communicatively coupling the first gateway unit to legacy telecommunications equipment from which the at least one telecommunications service is to be migrated, the legacy telecommunications equipment having a first set of cables communicatively coupled thereto to enable data associated with the at least one telecommunications service to be communicated via the telecommunications network;

communicatively coupling the second gateway unit to the legacy telecommunications equipment via the first gateway unit, the second gateway unit having a second set of cables communicatively coupled thereto to enable data associated with the at least one telecommunications service to be communicated via the telecommunications network, the second gateway unit may be communicatively couplable to the replacement telecommunications equipment to which the at least one telecommunications service is to be migrated; and

enabling data associated with the at least one telecommunications service to be communicated between the second gateway unit and the legacy telecommunications equipment via first gateway unit the prior to the at least one telecommunications service may be migrated to the replacement telecommunications equipment.

In accordance with sixth embodiments, there is a computer program product that may comprise a non-transitory computer-readable storage medium having computer readable instructions stored thereon, the computer readable instructions may be executable by a computerized device to cause the computerized device to perform a method of configuring a set of gateway units to be used in migrating at least one telecommunications service from legacy telecommunications equipment to replacement telecommunications equipment in a telecommunications network, the set of gateway units may comprise at least a first gateway unit and a second gateway unit, the method may comprise:

communicatively coupling the first gateway unit to legacy telecommunications equipment from which the at least one telecommunications service is to be migrated, the legacy telecommunications equipment having a first set of cables communicatively coupled thereto to enable data associated with the at least one telecommunications service to be communicated via the telecommunications network;

communicatively coupling the second gateway unit to the legacy telecommunications equipment via the first gateway unit, the second gateway unit having a second set of cables communicatively coupled thereto to enable data associated with the at least one telecommunications service to be communicated via the telecommunications network, the second gateway unit and may be communicatively couplable to the replacement telecommunications equipment to which the at least one telecommunications service is to be migrated; and

enabling data associated with the at least one telecommunications service to be communicated between the second gateway unit and the legacy telecommunications equipment via first gateway unit the prior to the at least one telecommunications service may be migrated to the replacement telecommunications equipment.

In accordance with seventh embodiments, there is a method of configuring a gateway unit to be used in migrating at least one telecommunications service from legacy telecommunications equipment to replacement telecommunications equipment in a telecommunications network, the method may comprise:

during a first phase:

communicatively coupling the gateway unit to at least one other gateway unit, the at least one other gateway unit may be communicatively coupled to the legacy telecommunications equipment; and

enabling data associated with the at least one telecommunications service to be communicated between the gateway unit and the legacy telecommunications equipment via the at least one other gateway unit;

during a second phase:

communicatively coupling the gateway unit to the replacement telecommunications equipment; and

enabling data associated with the at least one telecommunications service to be communicated between the gateway unit and the replacement telecommunications equipment.

In accordance with eighth embodiments, there is a gateway unit configured to be used in migrating at least one telecommunications service from legacy telecommunications equipment to replacement telecommunications equipment in a telecommunications network, the gateway unit may comprise:

a first communications interface via which the gateway unit is communicatively couplable to at least one other gateway unit, the at least one other gateway unit may be communicatively coupled to the legacy telecommunications equipment;

a second communications interface to which a set of set of cables are connectable to enable data associated with the at least one telecommunications service to be communicated via the telecommunications network;

a third communications interface via which the gateway unit is communicatively couplable to the replacement telecommunications equipment; and

at least one processor that is operable to enable data associated with the at least one telecommunications service to be communicated between the gateway unit and the legacy telecommunications equipment via the first communications interface during a first phase and to enable data associated with the at least one telecommunications service to be communicated between the gateway unit and the replacement telecommunications equipment via the third communications interface during a second phase.

In accordance with ninth embodiments, there is computer software adapted to perform a method of configuring a gateway unit to be used in migrating at least one telecommunications service from legacy telecommunications equipment to replacement telecommunications equipment in a telecommunications network, the method may comprise:

during first phase:

communicatively coupling the gateway unit to at least one other gateway unit, the at least one other gateway unit may be communicatively coupled to the legacy telecommunications equipment; and

enabling data associated with the at least one telecommunications service to be communicated between the gateway unit and the legacy telecommunications equipment via the at least one other gateway unit;

during a second phase:

communicatively coupling the gateway unit to the replacement telecommunications equipment; and

enabling data associated with the at least one telecommunications service to be communicated between the gateway unit and the replacement telecommunications equipment.

In accordance with tenth embodiments, there is a computer program product that may comprise a non-transitory computer-readable storage medium having computer readable instructions stored thereon, the computer readable instructions may be executable by a computerized device to cause the computerized device to perform a method of configuring a gateway unit to be used in migrating at least one telecommunications service from legacy telecommunications equipment to replacement telecommunications equipment in a telecommunications network, the method may comprise:

during a first phase:

communicatively coupling the gateway unit to at least one other gateway unit, the at least one other gateway unit may be communicatively coupled to the legacy telecommunications equipment; and

enabling data associated with the at least one telecommunications service to be communicated between the gateway unit and the legacy telecommunications equipment via the at least one other gateway unit;

during a second phase:

communicatively coupling the gateway unit to the replacement telecommunications equipment; and

enabling data associated with the at least one telecommunications service to be communicated between the gateway unit and the replacement telecommunications equipment.

Further features and advantages will become apparent from the following description of embodiments, given by way of example only, which is made with reference to the accompanying drawings.

### BRIEF DESCRIPTION OF THE DRAWINGS

FIG. 1 shows schematically a first apparatus configured to be used in migrating at least one telecommunications service in accordance with embodiments;

FIG. 2 shows schematically a second apparatus configured to be used in migrating at least one telecommunications service in accordance with embodiments;

FIG. 3 shows schematically a third apparatus configured to be used in migrating at least one telecommunications service in accordance with embodiments;

FIG. 4 shows schematically a first pre-cutover configuration of an apparatus configured to be used in migrating at least one telecommunications service during a first pre-cutover phase of a migration process in accordance with embodiments;

FIG. 5 shows schematically a second pre-cutover configuration of an apparatus configured to be used in migrating at least one telecommunications service during a second pre-cutover phase of a migration process in accordance with embodiments;

FIG. 6 shows schematically a third pre-cutover configuration of an apparatus configured to be used in migrating at least one telecommunications service during a third pre-cutover phase of a migration process in accordance with embodiments;

FIG. 7 shows schematically a fourth pre-cutover configuration of an apparatus configured to be used in migrating at least one telecommunications service during a fourth pre-cutover phase of a migration process in accordance with embodiments;

FIG. 8 shows schematically a first post-cutover configuration of an apparatus during a first post-cutover phase of a migration process in accordance with embodiments; and

FIG. 9 shows schematically a second post-cutover configuration of an apparatus during a second post-cutover phase of a migration process in accordance with embodiments.

### DETAILED DESCRIPTION OF CERTAIN INVENTIVE EMBODIMENTS

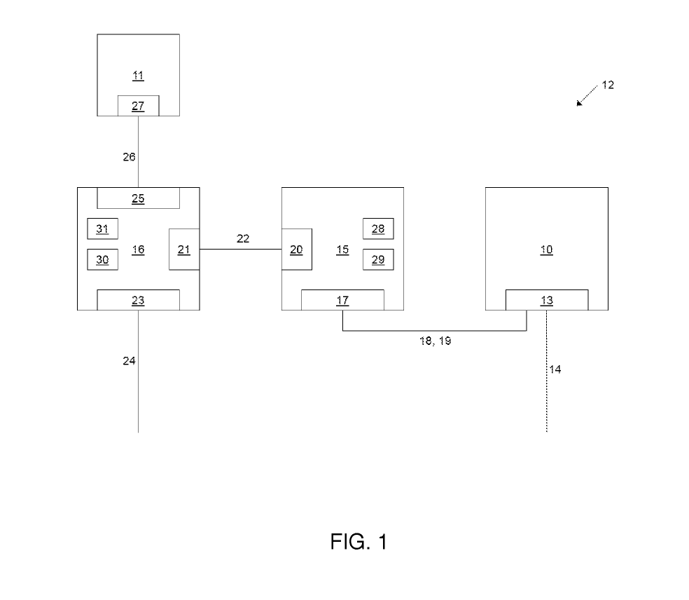

FIG. 1 depicts a first apparatus configured to be used in migrating at least one telecommunications service from legacy telecommunications equipment 10 to replacement telecommunications equipment 11 in a telecommunications network 12. The term apparatus as used herein encompasses one or more than one physical entity.

In one embodiment, the at least one telecommunications service includes at least one telephony service. In one such embodiment, the at least one telephony service is a telephony switching service. For example, the telephony switching service may be used to perform switching of telephone calls. The at least one telecommunications service may include at least one non-telephony service. Examples of such non-telephony services include, but are not limited to, streaming media services and data file transfer services.

In one embodiment, the telecommunications network 12 includes at least one telephony network. Examples of such telephony networks include, but are not limited to, a public switched telephone network (PSTN), public land mobile network (PLMN) and a packet-based network that supports communication of telephony data. Telephony data includes data such as signaling and/or media data associated with telephone calls. The telecommunications network 12 may include one or more networks other than the at least one telephony network.

The first apparatus may comprise the legacy telecommunications equipment 10 from which the at least one telecommunications service is to be migrated.

The legacy telecommunications equipment 10 may comprise one or more physical devices. For example, the legacy telecommunications equipment 10 may comprise a plurality of physical hardware devices. Examples of such physical hardware devices include, but are not limited to, server devices such as server blades configured to be used in a blade server. Some of the physical hardware devices may be active (or ‘primary’) devices and other such physical hardware devices may be standby (or ‘backup’) devices, to provide redundancy in the event of a failure of one of the active devices. In some implementations, the legacy telecommunications equipment 10 may comprise tens or more of such physical hardware devices.

The plurality of physical devices may be arranged, for example, in a plurality of equipment bays in one or more racks or cabinets. In some embodiments, at least some of the plurality of physical devices are located in substantially the same geographical location as each other. In some such embodiments, all of the plurality of physical devices are located in substantially the same geographical location as each other. In some embodiments, at least some of the plurality of physical devices are located in different geographical locations from each other.

The legacy telecommunications equipment 10 has a first communications interface 13. The term communications interface is used herein to include one physical and/or logical interface on a single physical device, a plurality of physical and/or logical interfaces on a single physical device and a plurality of physical and/or logical interfaces on a plurality of physical devices. The term physical interface is used herein to indicate an item of hardware that provides interface functionality. Non-limiting examples of such interfaces include network interface cards. The term logical interface is used herein to indicate an interface that need not be manifested in a dedicated item of hardware. A single physical interface may support a plurality of logical or virtual interfaces. The term virtual interface is used herein to indicate an interface that may or may not correspond to a physical interface.

Thus, for example, where the legacy telecommunications equipment 10 may comprise multiple physical devices, the first communications interface 13 of the legacy telecommunications equipment 10 may comprise multiple different physical interfaces provided in multiple different physical devices. The legacy telecommunications equipment 10 may have at least one additional communications interface in addition to the first communications interface 13. The at least one additional communications interface may be a different type of interface to the type of the first communications interface 13, but it could alternatively be of the same type.

The first communications interface 13 includes a number of network termination connectors. The network termination connectors of the first communications interface 13 of the legacy telecommunications equipment 10 are, in one embodiment, arranged to receive cables to enable data associated with the at least one telecommunications service to be communicated via the telecommunications network 12.

Various different types of network termination connectors could be used, depending on implementation, the type of legacy telecommunications equipment 10 and suchlike. Examples, of possible types of network termination connectors include, but are not limited to, Transmission System 1 (T1), E-carrier 1 (E1), Digital Signal 1 (DS-1) and Digital Signal 3 (DS-3) network termination connectors. An example of a DS-3 network termination connector is a Bayonet Neill-Concelman (BNC) connector.

Each of the network termination connectors is associated with a number of ports (or ‘lines’). One or more ports (or ‘lines) will be used for transferring data during a communications session and then, upon termination of the communications session, will be freed up for use in another communications session. The number of ports with which each network termination connector is associated depends on, for example, the type of network termination connector. In one embodiment, the network termination connector is associated with in the region of 200-600 ports. A relatively small telephone switch with, for example, 10,000 ports may have in the region of 15-50 network termination connectors. A relatively large telephone switch with, for example, 70,000-100,000 ports may have in the region of 100-500 network termination connectors. If two ports per session is assumed, the number of ports corresponds to twice the maximum number of simultaneous telecommunications sessions involving two parties that can be handled by the legacy telecommunications equipment 10.

In some embodiments, the legacy telecommunications equipment 10 has at least 70,000 ports. In some embodiments, the legacy telecommunications equipment 10 has in the region of 70,000-100,000 ports. In some embodiments, the legacy telecommunications equipment 10 has at least 100 network termination connectors. In some embodiments, the legacy telecommunications equipment 10 has in the region of 100-500 network termination connectors.

In one embodiment, the data associated with the at least one telecommunications service may comprise media and/or signaling data associated with the at least one telecommunications service.

A set of cables 14, referred to herein as the first set of cables 14, is communicatively coupled to the network termination connectors of the first communications interface 13 of the legacy telecommunications equipment 10. The terms communicatively coupled, communicative coupling and similar terms are used herein to indicate any coupling that allows communication of data. Examples of communicative couplings include, but are not limited to, a direct physical connection, an indirect physical connection via one or more intermediate entities, and a non-physical connection, such as a wireless connection. The first set of cables 14 is used to enable data associated with the at least one telecommunications service to be communicated via the telecommunications network 12. The first set of cables 14 may comprise at least one cable, but may comprise a plurality of cables. Different types of cable can be used for the first set of cables 14 in different scenarios. Examples of possible types of cables include, but are not limited to, twisted pair cabling, optical fiber cabling and coaxial cabling.

In some embodiments, the legacy telecommunications equipment 10 handles data, such as traffic, in legacy formats. In some embodiments, the legacy telecommunications equipment 10 handles legacy Time-division Multiplex (TDM) voice data. In some embodiments, the legacy telecommunications equipment 10 handles legacy signaling data. Examples of legacy signaling data include, but are not limited to, Signaling System No. 7 (SS7) and Integrated Services Digital Network (ISDN) signaling formats.

In addition to the legacy telecommunications equipment 10, the first apparatus includes a set of gateway units. The set of gateway units includes at least a first gateway unit 15 and a second gateway unit 16. The set of gateway units can include at least one additional gateway unit, in addition to the first and second gateway units 15, 16. The first gateway unit 15 may be thought of as a primary gateway unit and the second gateway unit 16 may be thought of as a secondary (or ‘helper’, as in helping the migration process) gateway unit.

The term gateway unit is used herein to indicate an entity that performs at least some functions associated with a gateway. Functions associated with a gateway include, but are not limited to, converting between different data formats and/or protocols. In one embodiment, the first and second gateway units 15, 16 receive data in a legacy format and convert that data into a different, or next-generation, i.e. newer, format or vice versa. The first and second gateway units 15, 16 may perform other functions in addition to conversion. For example, the first and second gateway units 15, 16 may perform media-related functions. Examples of such media related functions include echo cancellation and/or tone generation, such as Dual-Tone Multi-Frequency (DTMF) generation. In some embodiments, the first and/or second gateway units 15, 16 are stand-alone physical devices. In other embodiments, the first and/or second gateway units 15, 16 are incorporated into one or more other network entities.

Similar to the legacy telecommunications equipment 10, the first gateway unit 15 may comprise one or more physical devices, which may be arranged in various different configurations in the same or a similar manner to that described above in relation to the legacy telecommunications equipment 10.

The first gateway unit 15 has a first communications interface 17. The first communications interface 17 of the first gateway unit 15 includes a number of network termination connectors. The network termination connectors of the first communications interface 17 of the first gateway unit 15 are arranged to receive cables to enable data associated with the at least one telecommunications service to be communicated.

The first communications interface 17 and the type and number of network termination connectors of the first communications interface 17 can take various different forms, depending on, for example, implementation and the type of the first gateway unit 15. In one embodiment, the type of the network termination connectors of the first communications interface 17 of the first gateway unit 15 corresponds to the type of network termination connectors of the first communications interface 13 of the legacy telecommunications equipment 10. For example, the network termination connectors of the first communications interface 17 of the first gateway unit 15 and the network termination connectors of the first communications interface 13 of the legacy telecommunications equipment 10 may both be T1, E1, DS1 and/or DS3 network termination connectors.

The first gateway unit 15 is communicatively coupled to the legacy telecommunications equipment 10. The communicative coupling via which the first gateway unit 15 is communicatively coupled to the legacy telecommunications equipment 10 is indicated in FIG. 1 using the reference sign 18.

In one embodiment, the first gateway unit 15 is communicatively coupled to the legacy telecommunications equipment 10 via a set of cables 19 to enable data associated with the at least one telecommunications service to be communicated. This set of cables 19 is referred to herein as the third set of cables 19. The third set of cables 19 may comprise at least one cable. In this embodiment, the communicative coupling 18 between the first gateway unit 15 and the legacy telecommunications equipment 10 includes the third set of cables 19.

The first gateway unit 15 has a second communications interface 20. As will be described in more detail below, in some embodiments, the first gateway unit 15 can communicate with the second gateway unit 16 via the second communications interface 20 of the first gateway unit 15. The first gateway unit 15 may have at least one additional communications interface in addition to the first communications interface 17 and the second communications interface 20. Various different types of interface could be used for the second communications interface 20 of the first gateway unit 15. Examples include, but are not limited to, Ethernet interfaces.

As explained above, the set of gateway units also includes the second gateway unit 16. Similar to the legacy telecommunications equipment 10 and the first gateway unit 15, the second gateway unit 16 may comprise one or more physical devices, which can be arranged in various different configurations.

In one embodiment, the second gateway unit 16 has a first communications interface 21. Various different types of interface could be used for the first communications interface 21 of the second gateway unit 16. Examples include, but are not limited to, Ethernet interfaces.

In one embodiment, the second gateway unit 16 is communicatively coupled to the first gateway unit 15 via a coupling which is indicated in FIG. 1 using the reference sign 22.

The second gateway unit 16 is configurable to communicate data with the first gateway unit 15 via the first communications interface 21 of the second gateway unit 16, the coupling 22 between the second gateway unit 16 and the first gateway unit 15 and the second communications interface 20 of the first gateway unit 15. As explained above, the first gateway unit 15 is also communicatively coupled to the legacy telecommunications equipment 10 via the communicative coupling 18 between the first gateway unit 15 and the legacy telecommunications equipment 10. The second gateway unit 16 is thus communicatively coupled to the legacy telecommunications equipment 10 via the first gateway unit 15. This apparatus enables data associated with the at least one telecommunications service to be communicated between the second gateway unit 16 and the legacy telecommunications equipment 10 via the first gateway unit 15.

In one embodiment, data is communicated in this way prior to the at least one telecommunications service being migrated to the replacement telecommunications equipment 11.

In some embodiments, the communication of at least some of the data between the second gateway unit 16 and the legacy telecommunications equipment 10 via the first gateway unit 15 is bi-directional. In other words, the second gateway unit 16 and the legacy telecommunications equipment 10 can communicate data to and from each other via the first gateway unit 15.

In other embodiments, the communication of at least some of the data between the second gateway unit 16 and the legacy telecommunications equipment 10 via the first gateway unit 15 is uni-directional. For example, the first set of cables 14 might carry incoming data for the legacy telecommunications equipment 10 and the second set of cables 24 might carry outgoing data from the legacy telecommunications equipment 10 or vice versa.

As explained above, in one embodiment, the first and second gateway units 15, 16 are communicatively coupled to each other using at least one cable. In one embodiment, the first and second gateway units 15, 16 are communicatively coupled to each other using fewer cables than the number of network termination connectors of the legacy telecommunications equipment 10. In other words, in this embodiment, the first and second gateway units 15, 16 are communicatively coupled to each other using a number of cables, where that number of cables is less than the number of network termination connectors of the first communications interface 13 of the legacy telecommunications equipment 10.

In one embodiment, the first and second gateway units 15, 16 are communicatively coupled to each other directly. The first and second gateway units 15, 16 may be communicatively coupled to each other directly using at least one cable.

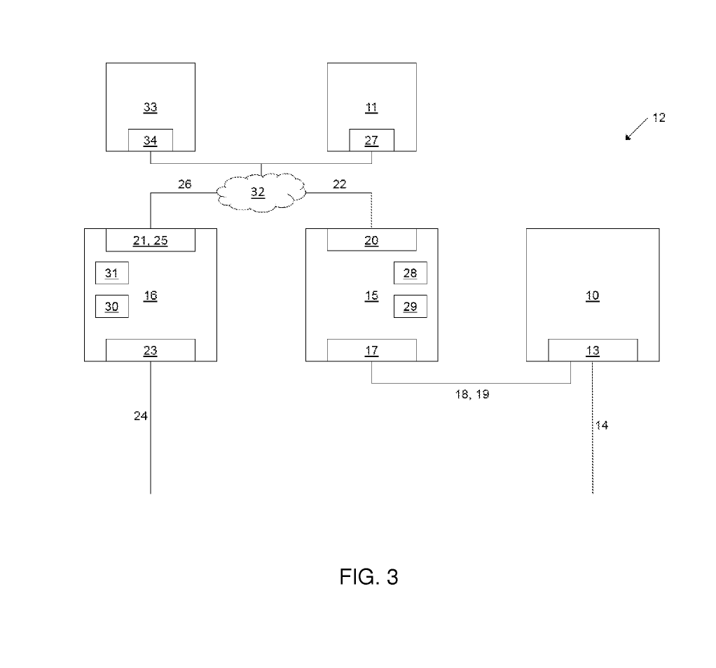

In another embodiment, the first and second gateway units 15, 16 are communicatively coupled to each other indirectly. The first and second gateway units 15, 16 may be communicatively coupled to each other indirectly using at least one cable. The first and second gateway units 15, 16 may be indirectly coupled to each other via one or more intermediate entities. In one specific embodiment, the one or more intermediate entities include the replacement telecommunications equipment 11. In another specific embodiment, the one or more intermediate entities include at least one gateway unit controller, which is described in more detail below with reference to FIG. 3.

In one embodiment, the first and second gateway units 15, 16 are communicatively coupled to each other via at least one packet-based network. In one embodiment, the first and second gateway units 15, 16 are communicatively coupled to each other using at least one Ethernet connection. Ethernet connectivity may allow the first and second gateway units 15, 16 and/or different parts of the first and/or second gateway units 15, 16 to be physically located in different areas. Ethernet connectivity may also facilitate separation of the first and second gateway units 15, 16 following migration, as will be explained in more detail below. The first and second gateway units 15, 16 can, however, be communicatively coupled to each other in other ways. For example, the first and second gateway units 15, 16 may be communicatively coupled via at least one wireless connection.

In one embodiment, the second gateway unit 16 has a second communications interface 23. The second communications interface 23 of the second gateway unit 16 includes a number of network termination connectors. The network termination connectors of the second communications interface 23 of the second gateway unit 16 are arranged to receive cables to enable data associated with the at least one telecommunications service to be communicated via the telecommunications network 12.

The second communications interface 23 of the second gateway unit 16 and the type and number of network termination connectors of the second communications interface 23 of the second gateway unit 16 can take various different forms, depending on, for example, implementation and the type of the second gateway unit 16. In one embodiment, the type of the network termination connectors of the second communications interface 23 of the second gateway unit 16 corresponds to the type of network termination connectors of the first communications interface 13 of the legacy telecommunications equipment 10. For example, the network termination connectors of the second communications interface 23 of the second gateway unit 16 and the network termination connectors of the first communications interface 13 of the legacy telecommunications equipment 10 may both be T1, E1, DS1 and/or DS3 network termination connectors.

The second gateway unit 16 has a set of cables 24 communicatively coupled thereto. This set of cables 24 is referred to herein as the second set of cables 24. The second set of cables 24 is used to enable data associated with the at least one telecommunications service to be communicated via the telecommunications network 12. The second set of cables 24 includes at least one cable.

In one embodiment, the second gateway unit 16 has a third communications interface 25.

The second gateway unit 16 is communicatively couplable to the replacement telecommunications equipment 11 to which the at least one telecommunications service is to be migrated. The second gateway unit 16 is communicatively couplable to the replacement telecommunications equipment 11 in the sense that it is capable of being communicatively coupled to the replacement telecommunications equipment 11, but need not be currently coupled to the replacement telecommunications equipment 11. The communicative coupling via which the second gateway unit 16 is communicatively couplable to the replacement telecommunications equipment 11 is indicated in FIG. 1 using the reference sign 26.

In one embodiment, the second gateway unit 16 is communicatively coupled to the replacement telecommunications equipment 11 via the third communications interface 25 of the second gateway unit 16. In this embodiment, data can be communicated between the second gateway unit 16 and the replacement telecommunications equipment 11 via the via the third communications interface 25 of the second gateway unit 16, the communicative coupling 26 between the second gateway unit 16 and the replacement telecommunications equipment 11 and a first communications interface 27 of the replacement telecommunications equipment 11.

In one embodiment, the second gateway unit 16 is communicatively coupled to the replacement telecommunications equipment 11 by means of a different type of coupling than the type of coupling by means of which the first gateway unit 15 is communicatively coupled to the legacy telecommunications equipment 10. In other words, in this embodiment, the type of the communicative coupling 26 between the second gateway unit 16 and the replacement telecommunications equipment 11 is different from the type of the communicative coupling 18 between the first gateway unit 15 and the legacy telecommunications equipment 10.

In one embodiment, the second gateway unit 16 is configurable to transmit at least some data received via the second set of cables 24 to the legacy telecommunications equipment 10 via the first gateway unit 15.

In one embodiment, the second gateway unit 16 is configurable to transmit at least some data received from the legacy telecommunications equipment 16, via the first gateway unit 15, via the second set of cables 24.

In one embodiment, the second gateway unit 16 is configurable to transmit at least some data received via the second set of cables 24 to the replacement telecommunications equipment 11.

In one embodiment, the second and third sets of cables 24, 19 comprise the same number of cables as each other. In other embodiments, the second and third sets of cables 24, 19 comprise a different number of cables from each other.

In one embodiment, the first and/or second gateway unit 15, 16 has fewer than twice the number of network termination connectors than the number of network termination connectors of the legacy telecommunications equipment 10. In other words, in this embodiment, the number of network termination connectors of the first communications interface 17 of the first gateway unit 15 and/or the number of network termination connectors of the second communications interface 23 of the second gateway unit 16 is less than twice the number of network termination connectors of the first communications interface 13 of the legacy telecommunications equipment 10.

In one embodiment, the first and second gateway units 15, 16 have a combined number of network termination connectors which is greater than or equal to the number of network termination connectors of the legacy telecommunications equipment 10. In other words, in this embodiment, the sum of the number of network termination connectors of the first communications interface 13 of the legacy telecommunications equipment 10 and the number of network termination connectors of the second communications interface 23 of the second gateway unit 16 is greater than or equal to the number of network termination connectors of the first communications interface 13 of the legacy telecommunications equipment 10.

In one embodiment, the first and second gateway unit 15, 16 are arranged in a back-to-back configuration. By configuring the first and second gateway units 15, 16 in this way, a single logical set of gateways (or “gateway complex”) can be provided. Such a configuration may be able to support, for example, twice the number of ports or connections than the legacy telecommunications equipment 10 can support. Depending on the nature of the first and/or second gateway units 15, 16, the gateway complex may support another multiple of the number of ports or connections of the legacy telecommunications equipment 10. For example, the gateway complex could support more than twice the number of ports or connections of the legacy telecommunications equipment 10 or less than twice the number of ports or connections of the legacy telecommunications equipment 10.

In one embodiment, one or more of the legacy and/or replacement telecommunications equipment 10, 11 has telephony switching functionality. In addition to performing switching functions, the replacement telecommunications equipment 11 may be configured to provide call processing intelligence to be used in the selection of processes that can be applied to telephone calls, the ability to transfer telephone calls to other network elements, and management functions such as provisioning, fault detection and billing.

In one embodiment, one or more of the first and/or second gateway units 15, 16 may comprise media and/or signaling gateway functionality. In one embodiment, the first and/or second gateway unit 15, 16 is a media and/or signaling gateway.

In embodiments where the first and/or second gateway unit 15, 16 has both media and signaling gateway functionality, the need for distinct signaling and media gateway components may be eliminated.

In one embodiment, one or more of the first and/or second gateway units 15, 16 may comprise media gateway functionality. In some such cases, one or more of the first and/or second gateway units 15, 16 converts or translates between legacy media data formats and next-generation media data formats. The gateway units 15, 16 may, for example, convert between TDM and Internet Protocol (IP) formats. Media data may be transmitted in accordance with a protocol such as, but not limited to, the Real-time Transport Protocol (RTP).

In one embodiment, one or more of the first and/or second gateway units 15, 16 may comprise signaling gateway functionality. In such cases, one or more of the first and/or second gateway units 15, 16 converts between legacy signaling data formats and next-generation signaling data formats. For example, the first and/or second gateway unit 15, 16 may be configured to convert between legacy SS7 and/or ISDN formats and next-generation IP formats, such as the Session Initiation Protocol (SIP) format.

The replacement telecommunications equipment 11 may be implemented in various different ways. For example, the replacement telecommunications equipment 11 may be comprised in or may comprise at least one gateway unit controller, which will be described in more detail below. In a specific embodiment in which the first and/or second gateway unit 15, 16 is a media gateway unit, the replacement telecommunications equipment 11 could be comprised in or could comprise a media gateway controller. The replacement telecommunications equipment 11 could be implemented in other ways. For example, the replacement telecommunications equipment 11 could be implemented as a softswitch, service platform or call agent separate from a media gateway controller.

In one embodiment, one or more of the first and/or second gateway units 15, 16 are configurable to operate in a mode in which data associated with at least one telecommunications service is received in a first data format and corresponding data is transmitted. The corresponding data includes the data associated with the at least one telecommunications service in the same, first data format. In some embodiments, the corresponding data is transmitted in a second, different format, but includes the data associated with at least one telecommunications service in the first data format. For example, the data in the first format could be encapsulated or otherwise included in the corresponding data which transmitted in the second, different format.

In one embodiment, one or more of the first and/or second gateway units 15, 16 are configurable to operate in a mode in which data associated with at least one telecommunications service is received in a first data format and corresponding data is transmitted. The corresponding data includes the data associated with the at least one telecommunications service in a second, different data format. For embodiment, the first gateway unit 15 could receive data in a first format and transmit the data to the second gateway unit 16 in a second, different format. The second gateway unit 16 could then receive the data in the second format and transmit the data in the first format.

In one embodiment, the first gateway unit 15 may comprise at least one processor 28. The at least one processor 28 of the first gateway unit 15 is operable to enable the first gateway unit 15 to perform at least part of the methods that are used in migrating at least one telecommunications service from the legacy telecommunications equipment 10 to the replacement telecommunications equipment 11 as described herein

In one embodiment, the first gateway unit 15 may comprise at least one memory 29. The at least one memory 29 of the first gateway unit 15 may store computer software and/or computer program code that is adapted, when executed, to perform at least part of the methods that are used in migrating at least one telecommunications service from the legacy telecommunications equipment 10 to the replacement telecommunications equipment 11 as described herein.

In one embodiment, the second gateway unit 16 may comprise at least one processor 30. The at least one processor 30 of the second gateway unit 16 is operable to enable the second gateway unit 16 perform at least part of the methods that are used in migrating at least one telecommunications service from the legacy telecommunications equipment 10 to the replacement telecommunications equipment 11 as described herein

In one embodiment, the second gateway unit 16 may comprise at least one memory 31. The at least one memory 31 of the second gateway unit 16 may store computer software and/or computer program code that is adapted, when executed, to perform at least part of the methods that are used in migrating at least one telecommunications service from the legacy telecommunications equipment 10 to the replacement telecommunications equipment 11 as described herein.

In some embodiments, the first and second gateway units 15, 16 perform similar functions to each other. The first and second gateway units 15, 16 may, for example, both be media gateways. The first and second gateway units 15, 16 may, for example, be made by the same manufacturer. The first and second gateway units 15, 16 may, for example, be the same model of gateway unit as each other. Selecting or configuring the first and second gateway units 15, 16 in this way may, for example, improve interoperability, usability or the like.

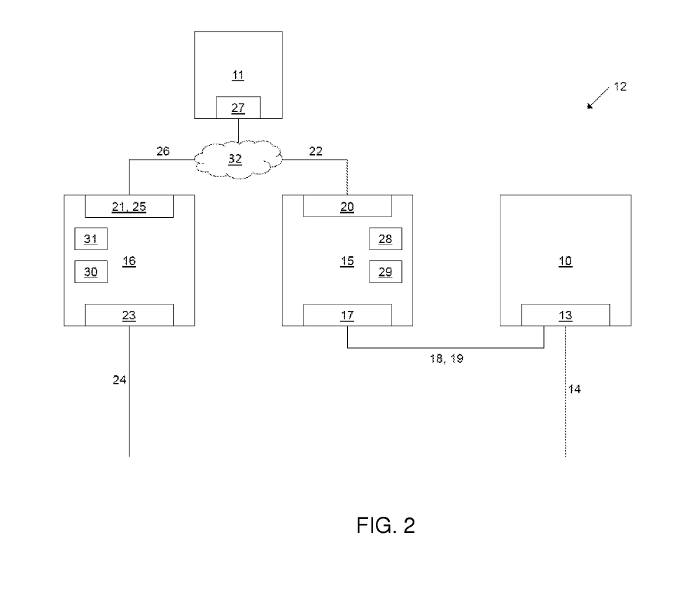

FIG. 2 depicts a second apparatus configured to be used in migrating a telecommunications service. The second apparatus is similar to the first apparatus depicted in FIG. 1 and described above.

In some embodiments, the telecommunications network 12 includes a packet-based network 32, for example the Internet.

In the second apparatus, the first communications interface 21 of the second gateway unit 16 is operable to communicate data via the packet-based network 32. In this embodiment, the third communications interface 25 of the second gateway unit 16 is also operable to communicate data via the packet-based network 32. Communicating data via the packet-based network 32 may comprise transmitting and/or receiving data via the packet-based network 32. The first and third communications interfaces 21, 21 may comprise different logical interfaces that share a common physical interface to communicate data via the packet-based network 32. The first and third communications interfaces 21, 21 may alternatively comprise different physical interfaces, both of which allow the second gateway unit 16 to communicate data via the packet-based network 32.

In this embodiment, the second gateway unit 16 is communicatively coupled to the replacement telecommunications equipment 11 via the third communications interface 25 of the second gateway unit 16, the packet-based network 32 and the first communications interface 27 of the replacement telecommunications equipment 11. In this embodiment, the communicative coupling 26 between the second gateway unit 16 and the replacement telecommunications equipment 11 includes the packet-based network 32.

In this embodiment, the second gateway unit 16 is communicatively coupled to the first gateway unit 15 via the first communications interface 21 of the second gateway unit 16, the packet-based network 11 and the second communications interface 20 of the first gateway unit 15. In this embodiment, the communicative coupling 22 between the second gateway unit 16 and the first gateway unit 15 includes the packet-based network 32.

In this embodiment, the second gateway unit 16 is communicatively coupled to the first gateway unit 15 and the replacement telecommunications equipment 11 via the same packet-based network 32. In this embodiment, the communicative coupling 26 between the second gateway unit 16 and the replacement telecommunications equipment 11, and the communicative coupling 22 between the second gateway unit 16 and the first gateway unit 15, both include the same packet-based network 32. In other embodiments, the second gateway unit 16 is communicatively coupled to the first gateway unit 15 via one packet-based network (not shown) and the second gateway unit 16 is communicatively coupled to the replacement telecommunications equipment 11 via a different packet-based network (not shown).

FIG. 3 depicts a third apparatus configured to be used in migrating at least one telecommunications service. The third apparatus is similar to the first and second apparatus depicted in FIGS. 1 and 2, and described above. However, the third apparatus, further includes at least one gateway unit controller 33.

Similar to the legacy telecommunications equipment 10, the first gateway unit 15, the second gateway unit 16, and the replacement telecommunications equipment 11, the at least one gateway unit controller 33 may comprise one or more physical devices.

In one embodiment, the at least one gateway unit controller 33 may comprise a first communications interface 34. In one specific embodiment, the first communications interface 34 of the at least one gateway unit controller 33 may comprise an interface to the packet-based network 32. In this specific embodiment, the at least one gateway unit controller 33 can communicate via a connection 35 to the packet-based network 32.

In one embodiment, the at least one gateway unit controller 33 can communicate data with the first gateway unit 15. In one specific embodiment, the at least one gateway unit controller 33 communicates data with the first gateway unit 15 via the first communications interface 34 of the at least one gateway unit controller 33, the packet-based network 32, and the second communications interface 20 of the first gateway unit 15.

In one embodiment, the at least one gateway unit controller 33 can communicate data with the second gateway unit 16. In one specific embodiment, the at least one gateway unit controller 33 communicates data with the second gateway unit 16 via the first communications interface 34 of the at least one gateway unit controller 33, the packet-based network 32, and the first and/or third communications interface 25, 21 of the second gateway unit 16.

In one embodiment, the at least one gateway unit controller 33 can communicate data with the replacement telecommunications equipment 11. In one specific embodiment, the at least one gateway unit controller 33 communicates data with the replacement telecommunications equipment 11 via the first communications interface 34 of the at least one gateway unit controller 33, the packet-based network 32, and the first communications interface 27 of the replacement telecommunications equipment 11.

The at least one gateway unit controller 33 is configured to control at least some operations of one or more of the first and/or second gateway units 15, 16. An example of such an operation that the at least one gateway unit controller 33 can control is the way in which the first gateway unit 15 communicates with the second gateway unit 16.

In one embodiment, the at least one gateway unit controller 33 controls a mapping between ports on the second gateway unit 16 and corresponding ports on the first gateway unit 15. The at least one gateway unit controller 33 may maintain the mapping in a mapping table, or otherwise.

In one embodiment, the at least one gateway unit controller 33 may comprise media gateway controller functionality. In one specific embodiment, the at least one gateway unit controller 33 may comprise Media Gateway Controller Function (MGCF) functionality. In some embodiments, the first and/or second gateway unit 15, 16 may comprise media gateway functionality. In such embodiments, the at least one gateway unit controller 33 may make use of standard media gateway control protocols to control the first and/or second gateway unit 15, 16. Examples of such standard media gateway control protocols include, but are not limited to, the Media Gateway Control Protocol (MGCP), the Gateway Control Protocol (Megaco or H.248) or Session Initiation Protocol (SIP).

In one embodiment, the at least one gateway unit controller 33 is separate from one or more of the first and/or second gateway units 15, 16, in the sense that the first and/or second gateway units 15, 16 do not comprise and are not comprised in the at least one gateway unit controller 33.

In one embodiment, the at least one gateway unit controller 33 may comprise or is comprised in the replacement telecommunications equipment 11. In such embodiments, the at least one gateway unit controller 33 may provide the call control functionality and/or signaling functionality of the replacement telecommunications equipment 11.

In another embodiment, the at least one gateway unit controller 33 is separate from the replacement telecommunications equipment 11, in the sense that the at least one gateway unit controller 33 does not comprise and is not comprised in the replacement telecommunications equipment 11.

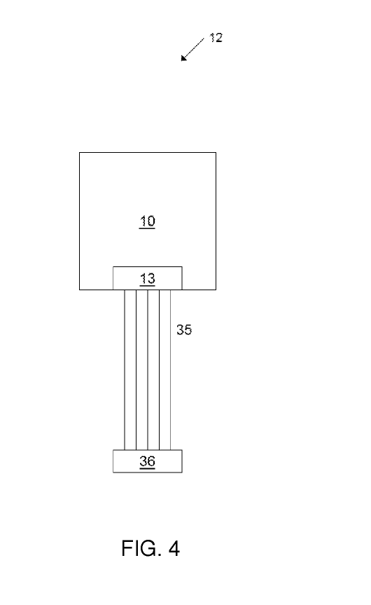

A method of configuring an apparatus to be used in migrating at least one telecommunications service will now be described with reference to FIGS. 4 to 9.

This method may be used to move traffic from the legacy telecommunications equipment 10 to the replacement telecommunications equipment 11 relatively quickly compared to at least some of prior art migration methodologies. By moving such traffic relatively quickly, migration may be performed with less downtime than is the case with at least some prior art migration techniques. This may be achieved by increasing the number of ports that are migrated collectively, in particular where a single cable is associated with multiple ports.

FIG. 4 shows a first pre-cutover configuration of an apparatus to be used in migrating at least one telecommunications service during a first pre-cutover phase.

In this first pre-cutover configuration, the apparatus includes the legacy telecommunications equipment 10 from which the at least one telecommunications service is to be migrated. The legacy telecommunications equipment 10 has a plurality of cables 35 communicatively coupled thereto to enable data associated with the at least one telecommunications service to be communicated via the telecommunications network 12.

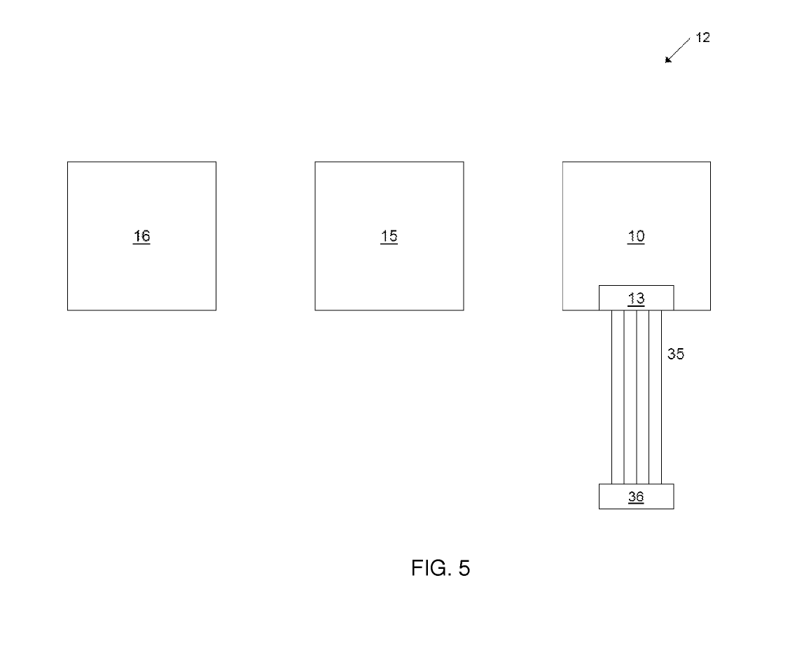

In the embodiments described below with reference to FIGS. 5 to 9, the cables in the plurality of cables 35 communicatively coupled to the legacy telecommunications equipment 10 may comprise the first set of cables 14 and the second set of cables 24 described above. In such embodiments, the second set of cables 24 that will be communicatively coupled to the second gateway unit 16 are initially comprised in the plurality of cables 35 communicatively coupled to legacy telecommunications equipment 10 and are moved from the legacy telecommunications equipment 10 to the second gateway unit 16.

In other embodiments, however, the cables in the plurality of cables 35 communicatively coupled to the legacy telecommunications equipment 10 do not comprise the second set of cables 24 described above. In such embodiments, the second set of cables 24 that will be communicatively coupled to the second gateway unit 16 are not initially comprised in the plurality of cables 35. Other such embodiments will be described in more detail below.

In this embodiment, the cables in the plurality of cables 35 are also communicatively coupled to at least one demarcation point 36. The at least one demarcation point 36 may include, for example, at least one cross-connect system. An example of a cross-connect system is a digital signal cross-connect (DSX) panel. Another example of a cross-connect system is a Digital Access and Cross-connect System (DACS) system. The at least one demarcation point 36 may be used to help connect network facilities to the legacy telecommunications equipment 10 correctly. The legacy telecommunications equipment 10 is thereby communicatively coupled to the at least one demarcation point 36 via the plurality of cables 35.

FIG. 5 shows a second pre-cutover configuration of an apparatus to be used in migrating at least one telecommunications service during a second pre-cutover phase.

In this second pre-cutover configuration, the apparatus includes the first gateway unit 15. The apparatus also includes the second gateway unit 16.

In one embodiment, the first and second gateway unit 15, 16 are installed in the same general location as the location of the legacy telecommunications equipment 10.

The second gateway unit 16 is communicatively couplable to the replacement telecommunications equipment 11 to which the at least one telecommunications service is to be migrated. In one embodiment, the replacement telecommunications equipment 11 does not form part of the apparatus in this second pre-cutover configuration. In another embodiment, however, the replacement telecommunications equipment 11 does form part of the apparatus in this second pre-cutover configuration. In this other embodiment, the second gateway unit 16 may be communicatively coupled to the replacement telecommunications equipment 11.

In this second pre-cutover phase, the cables in the plurality of cables 35 are still communicatively coupled to the legacy telecommunications equipment 10.

In some embodiments, the first and second gateway units 15, 16 are tested during the second pre-cutover phase. In other embodiments, the first and second gateway units 15, 16 are not tested during the second pre-cutover phase. For example, the first and second gateway units 15, 16 may be tested during a later stage, such as during the third pre-cutover phase described below.

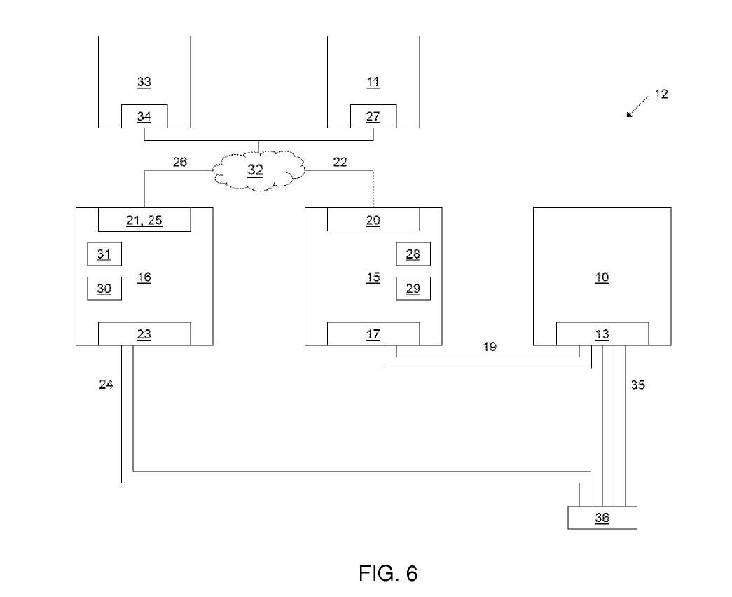

FIG. 6 shows a third pre-cutover configuration of an apparatus to be used in migrating at least one telecommunications service during a third pre-cutover phase.

In the third pre-cutover configuration, the apparatus also includes the replacement telecommunications equipment 11. The apparatus also includes the packet-based network 32. The apparatus also includes the at least one gateway unit controller 33.

In this embodiment, the second set of cables 24 that will be communicatively coupled to the replacement telecommunications equipment 11 are initially comprised in the plurality of cables 35. However, as explained above, other embodiments will be described later in which the second set of cables 24 that will be communicatively coupled to the replacement telecommunications equipment 11 are not initially comprised in the plurality of cables 35.

During the third pre-cutover phase, at least one of the cables in the plurality of cables 35 which was communicatively coupled to the legacy telecommunications equipment 10 during the second pre-cutover phase is uncoupled from the legacy telecommunications equipment 10. This may comprise physically disconnecting the at least one of the cables in the plurality of cables 35 from the legacy telecommunications equipment 10.

The at least one uncoupled cable may comprise at least part of the second set of cables 24 that is communicatively coupled to the second gateway unit 16.

In some such embodiments, the communicative coupling of the second set of cables 24 to the second gateway unit 16 is a direct physical connection. In such configurations, the second set of cables 24 is directly connected to network termination connectors of the second communications interface 23 of the second gateway unit 16. As such, the second set of cables 24 are moved from the legacy telecommunications equipment 10 and directly connected to the second gateway unit 16.

In other such embodiments, the communicative coupling of the second set of cables 24 is to the second gateway unit 16 is an indirect connection. In such other configurations, the connection is indirect in the sense that there is at least one intermediate entity between the second set of cables 24 and the second gateway unit 16. In one such other embodiment, the at least one intermediate entity may comprise at least one converter. The at least one converter has one set of connectors which match connectors on the second set of cables 24 and another set of connectors which match the network termination connectors of the second communications interface 23 of the second gateway unit 16. The at least one converter thereby allows the second set of cables 24 to be communicatively coupled to the second gateway unit 16. The at least one converter may be in the form of a converter cable.

The second gateway unit 16 is communicatively coupled to the first gateway unit 15. In this specific embodiment, the second gateway unit 16 is communicatively coupled to the first gateway unit 15 via the packet-based network 32. In this specific embodiment, the at least one gateway unit controller 33 is configured to control the communicative coupling between the first and second gateway unit 15, 16.

The first gateway unit 15 is communicatively coupled to the legacy telecommunications equipment 10. For example, the third set of cables 19 may be connected between the first communications interface 17 of the first gateway unit 15 and the first communications interface 13 of the legacy telecommunications equipment 10.

In one embodiment, the third set of cables 19 is directly connected to the one or more corresponding network termination connectors of the first communications interface 13 of the legacy telecommunications equipment 10 from which the second set of cables 24 have been physically disconnected.

In another embodiment, the third set of cables 19 is indirectly connected to the one or more corresponding network termination connectors of the first communications interface 13 of the legacy telecommunications equipment 10 from which the second set of cables 24 have been physically disconnected. The connection is indirect in the sense that there is at least one intermediate entity between the third set of cables 19 and the network termination connectors of the first communications interface 13 of the legacy telecommunications equipment 10 from which the second set of cables 24 have been physically disconnected. In one specific embodiment, the at least one intermediate entity includes at least one converter. The converter has one set of connections that match connections on the third set of cables 19 and another set of connections that match the network termination connectors of the first communications interface 13 of the legacy telecommunications equipment 10 from which the second set of cables 24 have been physically disconnected.

In some embodiments, the legacy telecommunications equipment 10 performs all of the processing of live traffic associated with the at least one telephony service which is to be migrated during the third pre-cutover phase. The term live traffic is used herein to distinguish from data used for testing purposes. In some embodiments, the replacement telecommunications equipment 11 does not perform any processing of live traffic associated with the at least one telephony service which is to be migrated during the third pre-cutover phase. However, the replacement telecommunications equipment 11 may process test data associated with the at least one telephony service which is to be migrated during the third pre-cutover phase.

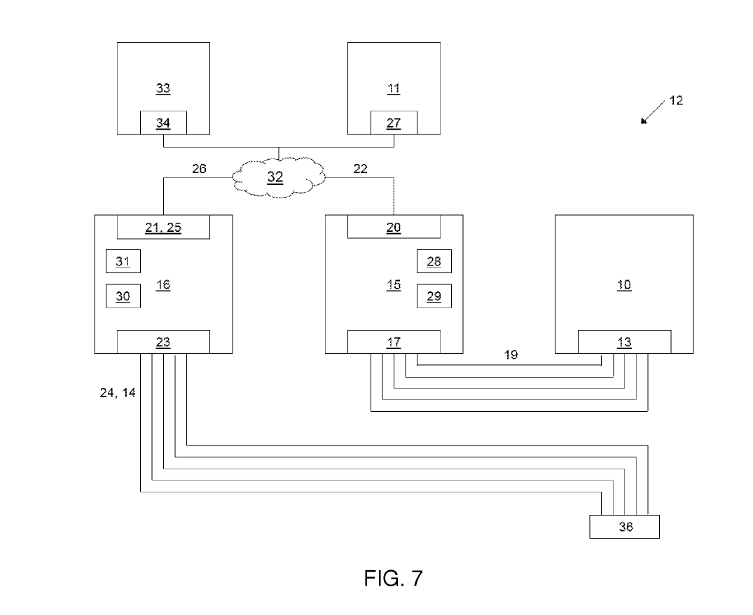

FIG. 7 shows a fourth pre-cutover configuration of an apparatus to be used in migrating at least one telecommunications service during a fourth pre-cutover phase.

The fourth pre-cutover configuration of the apparatus is similar to the third pre-cutover configuration of the apparatus, except that the cables in the plurality of cables 35 initially communicatively coupled to the legacy telecommunications equipment 10 are communicatively coupled to the second gateway unit 16 in the fourth pre-cutover configuration.

In some embodiments, all of the cables in the plurality of cables 35 initially communicatively coupled to the legacy telecommunications equipment 10 are communicatively coupled to the second gateway unit 16 in the fourth pre-cutover configuration. In other embodiments, at least some of the cables in the plurality of cables 35 initially communicatively coupled to the legacy telecommunications equipment 10 are not communicatively coupled to the second gateway unit 16 in the fourth pre-cutover configuration. For example, the at least some of the cables in the plurality of cables 35 might not be used to enable data associated with the at least one telecommunications service to be communicated via the telecommunications network 12 after the migration.

A specific embodiment will now be given, for the purposes of illustration only, to explain how this configuration enables data associated with the at least one telecommunications service to be communicated between the second gateway unit 16 and the legacy telecommunications equipment 10 via the first gateway unit 15 prior to the at least one telecommunications service being migrated to the replacement telecommunications equipment 11.

In this specific embodiment, a given cable in the plurality of cables 35 is initially connected to network termination connector A of the first communications interface 13 of the legacy telecommunications equipment 10. The given cable in the plurality of cables 35 is disconnected from the legacy telecommunications equipment 10 and is connected to a network termination connector B of second interface 23 of the second gateway unit 16 in the manner described above. The at least one gateway unit controller 33 determines a mapping between a port associated with network termination connector B of the second gateway unit 16 and a port associated with a network termination connector C of the first communications interface 17 of the first gateway unit 15. At least one cable in the third set of cables 19 is connected between network termination connector C of the first gateway unit 15 and network termination connector A of the first communications interface 13 of the legacy telecommunications equipment 10. In this way, the given cable in the plurality of cables 35 that was initially directly connected to network termination connector A of the legacy telecommunications equipment 10 is communicatively coupled to network termination connector A of the legacy telecommunications equipment 10 via the second gateway unit 16 and the first gateway unit 15.

The first and second gateway units 15, 16 are configured such that they are transparent to the telecommunications network 12. In other words, the telecommunications network 12 is unaware of the presence of the first and second gateway units 15, 16. In this specific embodiment, the first and second gateway units 15, 16 are also configured such that they are substantially transparent to the legacy telecommunications equipment 10. In other words, the telecommunications equipment 10 is substantially unaware of the presence of the first and second gateway units 15, 16.

In some embodiments, the legacy telecommunications equipment 10 performs all of the processing of live traffic associated with the at least one telephony service which is to be migrated during the fourth pre-cutover phase. In some embodiments, the replacement telecommunications equipment 11 does not perform any of the processing of live traffic associated with the at least one telephony service which is to be migrated during the fourth pre-cutover phase. However, the replacement telecommunications equipment 11 may process test data associated with the at least one telephony service which is to be migrated during the fourth pre-cutover phase.

During the transition between the fourth pre-cutover phase and the first post-cutover phase, which will be described below, at least one telecommunications service is migrated from the legacy telecommunications equipment 10 to the replacement telecommunications equipment 11.

In some embodiments, the configuration of the legacy telecommunications equipment 10 is transferred to the replacement telecommunications equipment 11. In one embodiment, the configuration is transferred by exporting the configuration from the legacy telecommunications equipment 10 and importing the configuration into the replacement telecommunications equipment 11. In some embodiments, transferal of the configuration from the legacy telecommunications equipment 10 to the replacement telecommunications equipment 11 may comprise converting the configuration from a legacy format to a different format which can be understood and used by the replacement telecommunications equipment 11. In other embodiments, the replacement telecommunications equipment 11 could be configured using new data that is not based on configuration of the legacy telecommunications equipment 10.

The replacement telecommunications equipment 11 is then ready to start processing live traffic associated with the at least one telecommunications service that has been migrated to the replacement telecommunications equipment 11. At an appropriate point in time, live traffic associated with the migrated service is cut-over from the legacy telecommunications equipment 10 to the replacement telecommunications equipment 11. The cutover may occur, for example, during a maintenance window. The term cutover is used herein to indicate the point at which the live traffic is cut-over to the replacement telecommunications equipment 11. The migration process includes phases prior to the cutover and phases after the cutover. Phases after the cutover could include, for example, testing of the cut-over traffic in relation to the replacement telecommunications equipment 11.

In some embodiments, at this stage, the at least one gateway controller 33 removes its mappings of the connections between the first and second gateway unit 15, 16. The at least one gateway controller 33 may be configured only to remove the mapping once the migration to the replacement telecommunications equipment 11 has been tested and/or after a predetermined amount of time has passed following the cutover.

At this stage, the at least one processor 30 of the second gateway unit 16 selectively enable data associated with the at least one telecommunications service to be communicated with the replacement telecommunications equipment 11 via the third communications interface 25 of the second gateway unit 16, instead of with the legacy telecommunications equipment 15 via the first communications interface 21 of the second gateway unit 16.

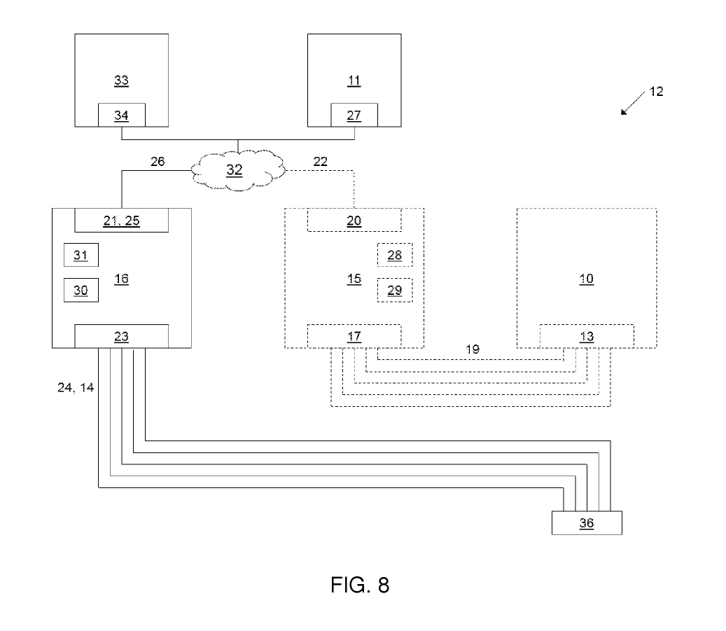

FIG. 8 shows a first post-cutover configuration of an apparatus during a first post-cutover phase.

During the first post-cutover phase, the replacement telecommunications equipment 11 provides connection information to the second gateway unit 16. In some embodiments, the replacement telecommunications equipment 11 provides connection information to enable the second gateway unit 16 to establish a communications session between two or more entities. The connection information includes identifiers for the two or more entities between which the communications session is to be established. For example, the replacement telecommunications equipment 11 receives dialed digits associated with a called party from a calling party. The replacement telecommunications equipment 11 then transmits a command to the second gateway unit 16 to instruct the second gateway unit 16 to connect a port associated with the calling party to a port associated with the called party, thereby establishing a communications session between the calling and called parties.

In some embodiments, the communicative coupling 22 between the second gateway unit 16 and the first gateway unit 15 need not be maintained post-cutover. In some embodiments, the first gateway unit 15 need not be used post-cutover. In some embodiments, the communicative coupling 18 between the first gateway unit 15 and the legacy telecommunications equipment 10, including the third set of cables 19, need not be maintained post-cutover. In some embodiments, the legacy telecommunications equipment 10 need not be used post-cutover. These entities are indicated using broken lines in FIG. 8.

Although these entities are no longer actively involved in communicating and/or processing data associated with the at least one telecommunications service that has been migrated to the replacement telecommunications equipment 11, they are still located in the same vicinity as that in which they were located during the pre-cutover phases. They might be retained in their respective positions for some period of time, for example to allow testing of the migration of the at least one telecommunications service to the replacement telecommunications equipment 11 or otherwise. In some embodiments, the entities indicated using broken lines in FIG. 8 can be retired in situ.

It will be appreciated, however, that the second gateway unit 16 remains actively involved in the apparatus post-cutover. The second gateway unit 16 may be considered therefore to form part of the post-cutover apparatus.

In some embodiments, the replacement telecommunications equipment 11 takes over control of the second gateway unit 16 at this stage. Furthermore, at this stage, the replacement telecommunications equipment 11 is responsible for processing live traffic associated with the at least one telephony service that has been migrated to the replacement telecommunications equipment 11.

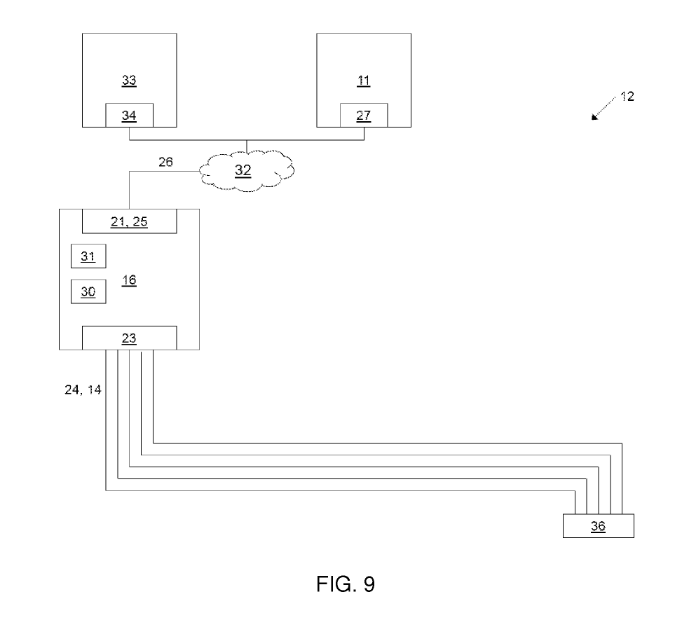

FIG. 9 shows a second post-cutover configuration of an apparatus during a second post-cutover phase.

In this apparatus, the entities indicated using broken lines in FIG. 8 are removed from the vicinity in which they were located during the pre-cutover phases. These entities can then be recovered, for example for reuse. In particular, the second gateway unit 16 and/or the third set of cables 19 could be recovered for reuse in another migration. It may be possible to reuse the legacy telecommunications equipment 10. Alternatively, as depicted in FIG. 8, the legacy telecommunications equipment 10 could be powered off and retired in situ.

In some embodiments, some of the entities indicated using broken lines in FIG. 8 could be retired in situ and others of the entities could be removed from the vicinity in which they were located during the pre-cutover phases.

In some cases, network operators may have invested significantly in legacy infrastructure, such as TDM control and transport equipment. At least some embodiments described above seek to enable network operators to migrate to next-generation equipment, whilst preserving at least some legacy (for example TDM) connectivity.

It will be appreciated that the embodiments described above may be implemented in various different types of hardware and/or software.

In one specific implementation, the first and/or second gateway unit 15, 16 could be implemented as a Universal Media Gateway (UMG), provided by Metaswitch™ Networks Ltd. Examples of such UMGs could include the MG6010 UMG and/or the MG6050 UMG, which feature an integrated signaling gateway as well as media gateway functionality. Other examples of such UMGs include the MG3510 UMG and/or the MG2510 UMG.

In one specific implementation, the at least one gateway unit controller 33 could be implemented as a MetaSphere™ Multimedia Telephony A^{pp} Server (MTAS), also provided by Metaswitch™ Networks Ltd.

Various measures (for example, apparatus and a method of configuring apparatus) to be used in migrating at least one telecommunications service from legacy telecommunications equipment to replacement telecommunications equipment in a telecommunications network are provided. The apparatus may comprise the legacy telecommunications equipment from which the at least one telecommunications service is to be migrated. The legacy telecommunications equipment has a first set of cables communicatively coupled thereto to enable data associated with the at least one telecommunications service to be communicated via the telecommunications network. The apparatus may comprise a first gateway unit communicatively coupled to the legacy telecommunications equipment. The apparatus may comprise a second gateway unit having a second set of cables communicatively coupled thereto to enable data associated with the at least one telecommunications service to be communicated via the telecommunications network. The second gateway unit is communicatively coupled to the legacy telecommunications equipment via the first gateway unit to enable data associated with the at least one telecommunications service to be communicated between the second gateway unit and the legacy telecommunications equipment via the first gateway unit prior to the at least one telecommunications service being migrated to the replacement telecommunications equipment. The second gateway unit is communicatively couplable to the replacement telecommunications equipment to which the at least one telecommunications service is to be migrated.

This provides a more scalable framework for migrating a telecommunications service. By using this apparatus during a pre-cutover phase, connections can be set up that are substantially transparent to the telecommunications network, but which facilitate the transfer of traffic to the replacement telecommunications equipment post-cutover

In some embodiments, the second gateway unit is communicatively coupled to the replacement telecommunications equipment. This can assist in reducing migration times, since the second gateway unit can have a dual-use as a component in the migration process and also as a component in the post-migration infrastructure.

In some embodiments, the second gateway unit is communicatively coupled to the replacement telecommunications equipment by means of a different type of communicative coupling from the type of communicative coupling by means of which the first gateway unit is communicatively coupled to the legacy telecommunications equipment.

In some embodiments, the second gateway unit is communicatively coupled to the replacement telecommunications equipment via a packet-based network. This provides flexibility in the migration procedure. For example, it enables replacement telecommunications equipment to be used which need not have the same type of communication interface as the legacy telecommunications equipment. It may also enable a more modern type of coupling to be used to communicatively couple the second gateway unit to the replacement telecommunications equipment, compared to the communicative coupling of the legacy telecommunications equipment.

In some embodiments, the second gateway unit is communicatively coupled to the first gateway unit via a packet-based network.

In some embodiments, the second gateway unit is communicatively coupled to the first gateway unit and the replacement telecommunications equipment via a packet-based network.

In some embodiments, the first gateway unit is communicatively coupled to the legacy telecommunications equipment via a third set of cables to enable data associated with the at least one telecommunications service to be communicated between the first gateway unit and the legacy telecommunications equipment.

In some embodiments, the second and third sets of cables may comprise the same number of cables as each other. This can facilitate the establishment and identification of logical connections between the second gateway unit and the first gateway unit.

In some embodiments, the legacy telecommunications equipment has a number of network termination connectors arranged to receive cables to enable data associated with the at least one telecommunications service to be communicated via the telecommunications network, and the first and/or second gateway unit has fewer than twice the number of network termination connectors than the number of network termination connectors of the legacy telecommunications equipment. This may facilitate large-scale migration where the legacy telecommunications equipment is relatively large compared to the size of the first and/or second gateway unit. If the first and/or second gateway units have the same as or more than twice the number of network termination connectors than the number of network termination connectors of the legacy telecommunications equipment, it may be possible to use whichever of the first and/or second gateway that has that number of network termination connectors for the migration.

In some embodiments, the legacy telecommunications equipment has a number of network termination connectors arranged to receive cables to enable data associated with the at least one telecommunications service to be communicated via the telecommunications network, and the first and second gateway units have a combined number of network termination connectors which is greater than or equal to the number of network termination connectors of the legacy telecommunications equipment. This may facilitate large-scale migration where the legacy telecommunications equipment is relatively large. In this apparatus, the first and second gateway units collectively comprise at least the same number of network termination connectors as the legacy telecommunications equipment.

In some embodiments, the legacy telecommunications equipment has a number of network termination connectors arranged to receive cables to enable data associated with the at least one telecommunications service to be communicated via the telecommunications network, and the first and second gateway units are communicatively coupled to each other using fewer cables than the number of network termination connectors of the legacy telecommunications equipment.

In some embodiments, the second gateway unit is configurable to transmit at least some data received via the second set of cables to the replacement telecommunications equipment.

In some embodiments, the second gateway unit is configurable to transmit at least some data received via the second set of cables to the legacy telecommunications equipment via the first gateway unit.

In some embodiments, the second gateway unit is configurable to transmit at least some data received from the replacement telecommunications equipment via the second set of cables

In some embodiments, the second gateway unit is configurable to transmit at least some data received from the legacy telecommunications equipment, via the first gateway unit, via the second set of cables.

In some embodiments, the legacy and/or replacement telecommunications equipment has telephony switching functionality.

In some embodiments, the first and/or second gateway unit may comprise media and/or signaling gateway functionality. The first and/or second gateway unit may be used as a component during a pre-cutover phase and may remain part of the infrastructure providing media and/or signaling gateway functionality following the cutover. This can improve the efficiency of the migration process, and reduce the amount of time taken for the migration to the replacement telecommunications equipment.

In some embodiments, the first and/or second gateway unit is a media and/or signaling gateway. The first and/or second gateway unit may be used as a component during a pre-cutover phase and may remain part of the infrastructure as a media and/or signaling gateway following the cutover. This can improve the efficiency of the migration process, and reduce the amount of time taken for the migration to the replacement telecommunications equipment.

In some embodiments, the data associated with the at least one telecommunications service may comprise media and/or signaling data associated with the at least one telecommunications service.

In some embodiments, the at least one telecommunications service includes at least one telephony service.

In some embodiments, the telecommunications network includes at least one telephony network.

In some embodiments, the first and/or second gateway units are configurable to operate in a mode in which data associated with at least one telecommunications service is received in a first data format and corresponding data is transmitted. The corresponding data includes the data associated with the at least one telecommunications service in the same, first data format. This may enable the first and/or second gateway units to appear substantially transparent to the telecommunications network. This can minimize the impact of their use in the migration on live services in the telecommunications network.

In some embodiments, the first and/or second gateway units are configurable to operate in a mode in which data associated with at least one telecommunications service is received in a first data format and corresponding data is transmitted. The corresponding data includes the data associated with the at least one telecommunications service in a second, different data format.

In some embodiments, the apparatus may comprise at least one gateway unit controller configured to control at least some operations of the first and/or second gateway units.

In some embodiments, the at least one gateway unit controller is separate from the first and/or second gateway units.

In some embodiments, the at least one gateway unit controller may comprise or is comprised in the replacement telecommunications equipment. This can minimize the number of components used during and after the migration process.

In some embodiments, the at least one gateway unit controller is separate from the replacement telecommunications equipment.

In some embodiments, the at least one gateway unit controller may comprise media gateway controller functionality.

Various measures (for example a method, computer software adapted to perform a method, and a computer program product may comprise a non-transitory computer-readable storage medium having computer readable instructions stored thereon, the computer readable instructions may be executable by a computerized device to cause the computerized device to perform a method) of configuring a set of gateway units to be used in migrating at least one telecommunications service from legacy telecommunications equipment to replacement telecommunications equipment in a telecommunications network are provided. The set of gateway units may comprise at least a first gateway unit and a second gateway unit. The first gateway unit is communicatively coupled to legacy telecommunications equipment from which the at least one telecommunications service is to be migrated. The legacy telecommunications equipment has a first set of cables communicatively coupled thereto to enable data associated with the at least one telecommunications service to be communicated via the telecommunications network. The second gateway unit is communicatively coupled to the legacy telecommunications equipment via the first gateway unit. The second gateway unit has a second set of cables communicatively coupled thereto to enable data associated with the at least one telecommunications service to be communicated via the telecommunications network. The second gateway unit is communicatively couplable to the replacement telecommunications equipment to which the at least one telecommunications service is to be migrated. Data associated with the at least one telecommunications service is enabled to be communicated between the second gateway unit and the legacy telecommunications equipment via the first gateway unit prior to the at least one telecommunications service being migrated to the replacement telecommunications equipment.

In some embodiments, the second gateway unit is communicatively coupled to the replacement telecommunications equipment.

In some embodiments, data associated with the at least one telecommunications service is enabled to be communicated between the second gateway unit and the replacement telecommunications equipment after the at least one telecommunications service is migrated to the replacement telecommunications equipment.

A set of gateways configured to be used in migrating at least one telecommunications service from legacy telecommunications equipment to replacement telecommunications equipment in a telecommunications network is provided. The set of gateway units may comprise at least a first gateway unit and a second gateway unit. The first gateway unit may comprise a first communications interface via which the first gateway unit is communicatively couplable to the legacy telecommunications equipment from which the at least one telecommunications service is to be migrated. The first gateway unit may comprise a second communications interface via which the first gateway unit is communicatively couplable to the second gateway unit. The first gateway unit may comprise at least one processor operable to enable data associated with the at least one telecommunications service to be communicated between the second gateway unit and the legacy telecommunications equipment via the first communications interface of the first gateway unit and second communications interfaces of the first gateway unit. The second gateway unit may comprise a first communications interface via which the second gateway unit is communicatively couplable to the first gateway unit. The second gateway unit may comprise a second communications interface to which a set of set of cables are connectable to enable data associated with the at least one telecommunications service to be communicated via the telecommunications network. The second gateway unit may comprise a third communications interface via which the second gateway unit is communicatively couplable to the replacement telecommunications equipment. The second gateway unit may comprise at least one processor operable to enable data associated with the at least one telecommunications service to be communicated, selectively, with the legacy telecommunications equipment via the first communications interface of the second gateway unit or with the replacement telecommunications equipment via the third communications interface of the second gateway unit.

Various measures (for example a method, computer software adapted to perform a method, and a computer program product that may comprise a non-transitory computer-readable storage medium having computer readable instructions stored thereon, the computer readable instructions may be executable by a computerized device to cause the computerized device to perform a method) of configuring a gateway unit to be used in migrating at least one telecommunications service from legacy telecommunications equipment to replacement telecommunications equipment in a telecommunications network are provided. During a first phase, the gateway unit is communicatively coupled to at least one other gateway unit. The at least one other gateway unit is communicatively coupled to the legacy telecommunications equipment. During the first phase, data associated with the at least one telecommunications service is enabled to be communicated between the gateway unit and the legacy telecommunications equipment via the at least one other gateway unit. During a second phase, the gateway unit is communicatively coupled to the replacement telecommunications equipment. During the second phase, data associated with the at least one telecommunications service is enabled to be communicated between the gateway unit and the replacement telecommunications equipment.

In some embodiments, the first phase occurs prior to cutover and the second phase occurs after cutover.

A gateway unit configured to be used in migrating at least one telecommunications service from legacy telecommunications equipment to replacement telecommunications equipment in a telecommunications network is provided. The gateway unit may comprise a first communications interface via which the gateway unit is communicatively couplable to at least one other gateway unit, the at least one other gateway unit may be communicatively coupled to the legacy telecommunications equipment. The gateway unit may comprise a second communications interface to which a set of set of cables are connectable to enable data associated with the at least one telecommunications service to be communicated via the telecommunications network. The gateway unit may comprise a third communications interface via which the gateway unit is communicatively couplable to the replacement telecommunications equipment. The gateway unit may comprise at least one processor that is operable to enable data associated with the at least one telecommunications service to be communicated between the gateway unit and the legacy telecommunications equipment via the first communications interface during a first phase and to enable data associated with the at least one telecommunications service to be communicated between the gateway unit and the replacement telecommunications equipment via the third communications interface during a second phase.

In some embodiments, the first phase occurs prior to cutover and the second phase occurs after cutover.

The above embodiments are to be understood as illustrative examples. Further embodiments are envisaged.

Embodiments have been described above in which the first and second gateway units 15, 16 are communicatively coupled to each other using a third set of cables 19. In embodiments, the first and second gateway units 15, 16 are communicatively coupled to each other using a coupling that is not a set of cables. In embodiments, the first and second gateway units 15, 16 are communicatively coupled via one or more wireless connections.

Embodiments have been described above in which the first and second gateway units 15, 16 are interconnected using packet-based technologies. Alternatively or additionally, the first and second gateway units 15, 16 can be interconnected using other types of connection.

Embodiments have been described above in which the first and second gateway units 15, 16 are physically distinct gateways. In embodiments, the first and second gateway units 15, 16 form part of a single, modular gateway complex, but are logically distinct within that gateway complex. Where the legacy telecommunications equipment 10 is relatively small, a single, modular gateway may have a sufficient number of network termination connectors to enable migration to be carried out in accordance with the embodiments described herein. For example, for legacy telecommunications equipment 10 with 10,000 ports, a single, modular gateway comprising the first and second gateway units 15, 16 and having at least 20,000 ports might be useable. However, if the legacy telecommunications equipment 10 is relatively large, a single, modular gateway might not have a sufficient number of network termination connectors to enable migration to be carried out in accordance with the embodiments described herein. For example, for legacy telecommunications equipment 10 with 70,000-100,000 ports it might not be possible to use a single, modular gateway comprising the first and second gateway units 15, 16 and having at least 140,000 ports.

Embodiments have been described above where the set of gateway units may comprise two gateway units; the first and second gateway units 15, 16. In embodiments, the set of gateway units may comprise more than two gateway units. The number of gateway units comprised in the set of gateway units may depend, for example, on what types of gateway unit are available for the migration, the sizes of the available gateway units and/or the legacy telecommunications equipment 10, or other factors.

In embodiments described above, only a single gateway unit, the first gateway unit 15, remains as part of the apparatus post-cutover. In embodiments, the second gateway unit 16 remains as part of the apparatus post-cutover. In still further embodiments, the set of gateway units used in the migration process may comprise more than two gateway units and at least two of the gateway units in the set remain as part of the apparatus post-cutover.

In some embodiments described above, the second set of cables 24 that is communicatively coupled to the second gateway unit 16 is comprised in the plurality of cables 35 that are initially communicatively coupled to the legacy telecommunications equipment 10. In such embodiments, one end of those cables remains connected to the at least one demarcation point 36 and the other end of those cables is moved from the legacy telecommunications equipment 10 to the second gateway unit 16.

In other embodiments, the second set of cables 24 that is communicatively coupled to the second gateway unit 16 is not comprised in the plurality of cables 35 that is initially communicatively coupled to the legacy telecommunications equipment 10. In such other embodiments, rather than retaining the connection at one end of those cables with the at least one demarcation point 36 and moving the other end of those cables to the second gateway unit 16, those cables can also be communicatively decoupled from the at least one demarcation point 36. A new set of cables can then be run from the at least one demarcation point 36 to the second gateway unit 16. The new set of cables would be the second set of cables 24 that are communicatively coupled to the second gateway unit 16. In other embodiments, a new set of cables can then be run from a point other than the at least one demarcation point 36 to the second gateway unit 16. For example, it might be desired to run the new cables from a different location from the location of the at least one demarcation point 36. The new set of cables would be the second set of cables 24 that are communicatively coupled to the second gateway unit 16.

Various different factors may be considered in deciding whether to disconnect cables from the legacy telecommunications equipment 10 and move those cables to the vicinity of the second gateway unit 16 while retaining the connection of those cables to the at least one demarcation point 36, or whether to disconnect those cables from both the at least one demarcation point 36 and the legacy telecommunications equipment 10 and run a new set of cables to the second gateway unit 16. One possible such factor is the relative locations of the first and/or second gateway units 15, 16 and the legacy telecommunications equipment 10. Another possible such factor is the ease of moving the second set of cables 24 to the vicinity of the replacement telecommunications equipment 11. Yet another possible such factor is whether it is desired to reuse the at least one demarcation point 36 post-cutover.

Embodiments have been described above in which the second gateway unit 16, the at least one gateway unit controller 33, and the replacement telecommunications equipment 11 are all physically distinct entities or components. Other embodiments have also been described above in which the at least one gateway unit controller 33 may comprise or is comprised in the replacement telecommunications equipment 11. In such other embodiments, the second gateway unit 16 and the combined at least one gateway unit controller 33 and replacement telecommunications equipment 11 are physically distinct entities or components. In further embodiments, the second gateway unit 16, the at least one gateway unit controller 33, and the replacement telecommunications equipment 11 are all comprised in the same physical or logical entity. For example, embodiments are envisaged in which the replacement telecommunications equipment 11 may comprise both gateway unit controller and gateway unit functionality. In such embodiments, communicative couplability should be understood to cover logical as well as physical couplability.

Embodiments have been described above which refer to cables and cabling. It will be appreciated that, instead of cables or cabling being used, another type of data transport medium or data communication medium could be used. Examples of other types of data transport media include, but are not limited to, air (for wireless communications) or another medium or media that can be physically connected to multiple entities to allow data to be communicated between those entities.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, several embodiments of which are defined in the accompanying claims.

What is claimed is:

1. A system configured to be used in migrating at least one telecommunications service from legacy telecommunications equipment to replacement telecommunications equipment in a telecommunications network, the system comprising:
the legacy telecommunications equipment from which the at least one telecommunications service is to be migrated, the legacy telecommunications equipment having a first set of cables communicatively coupled thereto to enable data associated with the at least one telecommunications service to be communicated via the telecommunications network;
a first gateway unit communicatively coupled to the legacy telecommunications equipment; and
a second gateway unit having a second set of cables communicatively coupled thereto to enable data associated with the at least one telecommunications service to be communicated via the telecommunications network, wherein:
the second gateway unit is communicatively coupled to the legacy telecommunications equipment via the first gateway unit to enable data associated with the at least one telecommunications service to be communicated between the second gateway unit and the legacy telecommunications equipment via the first gateway unit prior to the at least one telecommunications service being migrated to the replacement telecommunications equipment; and
the second gateway unit is communicatively couplable to the replacement telecommunications equipment to which the at least one telecommunications service is to be migrated.

2. The system according to claim 1, wherein the second gateway unit is communicatively coupled to the replacement telecommunications equipment.

3. The system according to claim 1, wherein the second gateway unit is communicatively coupled to the replacement telecommunications equipment by means of a different type of communicative coupling from the type of communicative coupling by means of which the first gateway unit is communicatively coupled to the legacy telecommunications equipment.

4. The system according to claim 1, wherein the second gateway unit is communicatively coupled to the replacement telecommunications equipment via a packet-based network.

5. The system according to claim 1, wherein the second gateway unit is communicatively coupled to the first gateway unit via a packet-based network.

6. The system according to claim 1, wherein the first gateway unit is communicatively coupled to the legacy telecommunications equipment via a third set of cables to enable data associated with the at least one telecommunications service to be communicated between the first gateway unit and the legacy telecommunications equipment.

7. The system according to claim 1, wherein the legacy telecommunications equipment has a number of network termination connectors arranged to receive cables to enable data associated with the at least one telecommunications service to be communicated via the telecommunications network, and wherein the first and/or second gateway unit has fewer than twice the number of network termination connectors than the number of network termination connectors of the legacy telecommunications equipment.

8. The system according to claim 1, wherein the legacy telecommunications equipment has a number of network termination connectors arranged to receive cables to enable data associated with the at least one telecommunications service to be communicated via the telecommunications network, and wherein the first and second gateway units have a combined number of network termination connectors which is greater than or equal to the number of network termination connectors of the legacy telecommunications equipment.

9. The system according to claim 1, wherein the legacy telecommunications equipment has a number of network termination connectors arranged to receive cables to enable data associated with the at least one telecommunications service to be communicated via the telecommunications network, and wherein the first and second gateway units are communicatively coupled to each other using fewer cables than the number of network termination connectors of the legacy telecommunications equipment.

10. The system according to claim 1, wherein the second gateway unit is configurable to transmit at least some data received via the second set of cables to the replacement telecommunications equipment.

11. The system according to claim 1, wherein the second gateway unit is configurable to transmit at least some data received via the second set of cables to the legacy telecommunications equipment via the first gateway unit.

12. The system according to claim 1, wherein the second gateway unit is configurable to transmit at least some data received from the replacement telecommunications equipment via the second set of cables

13. The system according to claim 1, wherein the second gateway unit is configurable to transmit at least some data received from the legacy telecommunications equipment, via the first gateway unit, via the second set of cables.

14. The system according to claim 1, wherein the first and/or second gateway unit comprises media and/or signaling gateway functionality.

15. The system according to claim 1, wherein the first and/or second gateway units are configurable to operate in a mode in which data associated with at least one telecommunications service is received in a first data format and corresponding data is transmitted, wherein the corresponding data includes the data associated with the at least one telecommunications service in the same, first data format.

16. The system according to claim 1, wherein the first and/or second gateway units are configurable to operate in a mode in which data associated with at least one telecommunications service is received in a first data format and corresponding data is transmitted, wherein the corresponding data includes the data associated with the at least one telecommunications service in a second, different data format.

17. The system according to claim 1, wherein the system comprises at least one gateway unit controller configured to control at least some operations of the first and/or second gateway units.

18. The system according to claim 17, wherein the at least one gateway unit controller comprises media gateway controller functionality.

19. A method of configuring a system to be used in migrating at least one telecommunications service from legacy telecommunications equipment to replacement telecommunications equipment in a telecommunications network, the system comprising:
the legacy telecommunications equipment from which the at least one telecommunications service is to be migrated, the legacy telecommunications equipment having at least a first set of cables communicatively coupled thereto to enable data associated with the at least one telecommunications service to be communicated via the telecommunications network;
a first gateway unit; and
a second gateway unit that is communicatively couplable to the replacement telecommunications equipment to which the at least one telecommunications service is to be migrated, the method comprising:
communicatively coupling a second set of cables to the second gateway unit to enable data associated with the at least one telecommunications service to be communicated via the telecommunications network;
communicatively coupling the second gateway unit to the first gateway unit; and
communicatively coupling the first gateway unit to the legacy telecommunications equipment.

20. A method of configuring a set of gateway units to be used in migrating at least one telecommunications service from legacy telecommunications equipment to replacement telecommunications equipment in a telecommunications network, the set of gateway units comprising at least a first gateway unit and a second gateway unit, the method comprising:
communicatively coupling the first gateway unit to legacy telecommunications equipment from which the at least one telecommunications service is to be migrated, the legacy telecommunications equipment having a first set of cables communicatively coupled thereto to enable data associated with the at least one telecommunications service to be communicated via the telecommunications network;
communicatively coupling the second gateway unit to the legacy telecommunications equipment via the first gateway unit, the second gateway unit having a second set of cables communicatively coupled thereto to enable data associated with the at least one telecommunications service to be communicated via the telecommunications network, the second gateway unit being communicatively couplable to the replacement telecommunications equipment to which the at least one telecommunications service is to be migrated; and
enabling data associated with the at least one telecommunications service to be communicated between the second gateway unit and the legacy telecommunications equipment via the first gateway unit prior to the at least one telecommunications service being migrated to the replacement telecommunications equipment.
